(19) United States
(12) Patent Application Publication
(10) Pub. No.: US 2026/0163301 A1
(43) Pub. Date: Jun. 11, 2026

(54) CONNECTOR

(71) Applicant: SUMITOMO WIRING SYSTEMS, LTD., Mie (JP)

(72) Inventor: Kazuki KOIDE, Mie (JP)

(21) Appl. No.: 19/360,099

(22) Filed: Oct. 16, 2025

(30) Foreign Application Priority Data
Oct. 17, 2024 (JP) 2024-181521

(51) Int. Cl. H01R 13/629

(52) U.S. Cl. CPC H01R 13/629

(57) ABSTRACT

A front member of a first connector includes a plate-shaped front wall. The front wall faces a front surface of a housing of the first connector. The front wall includes a through hole. The front surface of the housing includes a recess that communicates with the through hole. A second connector includes a twisting prevention projection that is located from the through hole to the recess. A part of the front wall facing the through hole includes a protrusion that protrudes into the recess and is capable of contacting an inner surface (lower inner surface) of the recess in a direction intersecting a front-rear direction.

### CROSS-REFERENCE TO RELATED APPLICATIONS

This application is based on and claims priority from Japanese Patent Application No. 2024-181521, filed on Oct. 17, 2024, with the Japan Patent Office, the disclosure of which is incorporated herein in its entirety by reference.

### TECHNICAL FIELD

The present disclosure relates to a connector.

### BACKGROUND

The connector described in JP 2002-313475 A includes a female housing and a male housing that are fittable together. A lateral rib is formed on the male housing. The lateral rib interferes with the female housing to prevent twisted fitting (insertion) (the term herein also includes tilted fitting (insertion) and prying) in the case where the female housing and the male housing assume a posture tilted with respect to the proper fitting posture. A plate-shaped front stopper portion is provided on the front side of the female housing. A lateral groove into which the lateral rib enters during fitting is formed in the front stopper portion. The lateral groove has a shape that extends longer in the left-right direction than in the up-down direction. JP 2009-181724 A discloses a connector that includes a twisting prevention portion corresponding to the lateral rib and a front holder corresponding to the front stopper portion.

### SUMMARY

An attempt may be made to fit another male housing different from the above-mentioned male housing to the female housing. Another lateral rib that slightly differs in shape from the above-mentioned lateral rib is formed on the other male housing. Since the shape of the other lateral rib does not match the shape of the above-mentioned lateral groove, it is possible to suppress fitting between the other male housing and the female housing from proceeding. However, there is a certain possibility that the other lateral rib is forcibly inserted into the lateral groove while increasing the opening width of the lateral groove by, for example, being guided by roundness provided at the leading end of the other lateral rib. In view of this, development of a technique that can more reliably prevent erroneous fitting between the other male housing and the female housing is needed.

The present disclosure accordingly has an object of providing a connector that can enhance reliability in preventing erroneous fitting.

A connector according to the present disclosure is a connector including a first connector and a second connector that are fittable together, wherein the first connector includes a first housing and a front member, the front member includes a plate-shaped front wall whose plate surfaces face in a front-rear direction, the front wall faces a front surface of the first housing, the front wall is provided with a through hole, the front surface of the first housing is provided with a recess that communicates with the through hole, the second connector includes a twisting prevention projection that is located from the through hole to the recess in a state in which the first connector and the second connector are fitted together, and a part of the front wall facing the through hole is provided with a protrusion that protrudes into the recess and is capable of contacting an inner surface of the recess in a direction intersecting the front-rear direction.

According to the present disclosure, it is possible to provide a connector that can enhance reliability in preventing erroneous fitting.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a front view of a first connector in Embodiment 1.

FIG. 2 is a side sectional view of the first connector in Embodiment 1.

FIG. 3 is a front view of a second connector in Embodiment 1.

FIG. 4 is a front view of another second connector in Embodiment 1.

FIG. 5 is a front view of still another second connector in Embodiment 1.

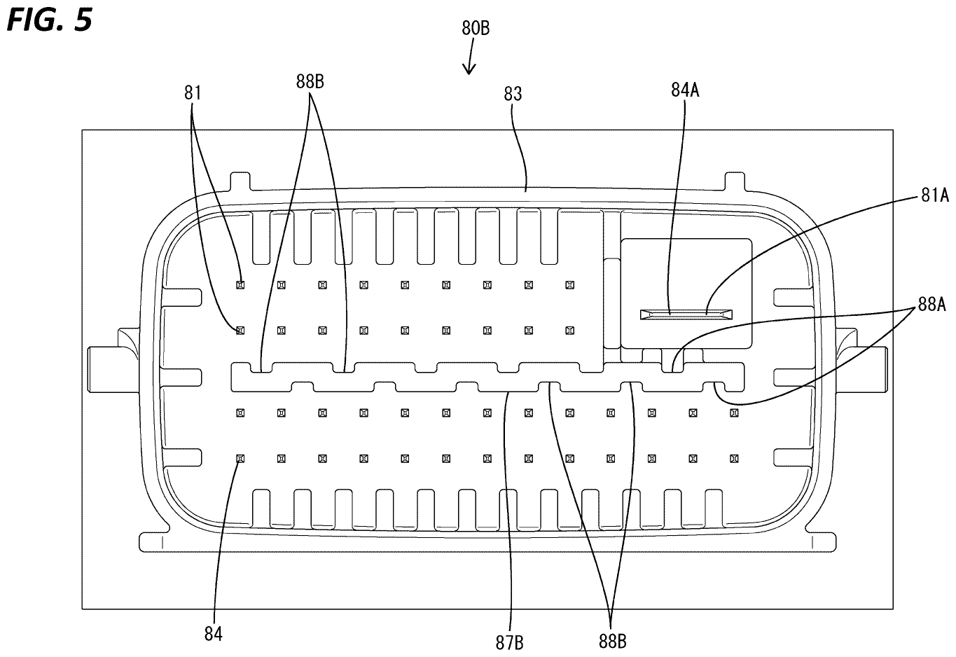

FIG. 6 is a front view of a first housing in Embodiment 1.

FIG. 7 is a rear perspective view of a front member in Embodiment 1.

FIG. 8 is a front view of the front member in Embodiment 1.

FIG. 9 is a front view of another first connector in Embodiment 1.

FIG. 10 is a front view of still another first connector in Embodiment 1.

FIG. 11 is a transverse sectional view showing a state in which a rearward protrusion portion of each protrusion is placed inside a recess in Embodiment 1.

FIG. 12 is an enlarged front view showing a state in which another twisting prevention projection interferes with a protrusion body portion of each protrusion in Embodiment 1.

FIG. 13 is an enlarged side sectional view showing a state in which another twisting prevention projection interferes with a protrusion body portion of a protrusion in Embodiment 1.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of the Present Disclosure

First, embodiments of the present disclosure will be listed and described.
(1) A connector according to the present disclosure is a connector including a first connector and a second connector that are fittable together, wherein the first connector includes a first housing and a front member, the front member includes a plate-shaped front wall whose plate surfaces face in a front-rear direction, the front wall faces a front surface of the first housing, the front wall is provided with a through hole, the front surface of the first housing is provided with a recess that communicates with the through hole, the second connector includes a twisting prevention projection that is located from the through hole to the recess in a state in which the first connector and the second connector are fitted together, and a part of the front wall facing the through hole is provided with a protrusion that protrudes into the recess and is capable of contacting an inner surface of the recess in a direction intersecting the front-rear direction.

For example, if an attempt is made to fit another second connector including another twisting prevention projection that slightly differs in shape from the twisting prevention projection to the first connector, the other twisting prevention projection may press against the hole surface of the through hole and cause a phenomenon called mouth-opening (i.e. opening expansion) in which the opening width of the through hole increases in a direction intersecting the front-rear direction. If mouth-opening of the through hole occurs and the other twisting prevention projection is forcibly inserted into the through hole, the other second connector will end up being erroneously fitted to the first connector. With the configuration in (1), even if the other twisting prevention portion presses against the hole surface of the through hole, the protrusion can contact the inner surface of the recess in the direction intersecting the front-rear direction, so that mouth-opening of the through hole can be avoided. Erroneous fitting of another second connector to the first connector can thus be prevented.
(2) Preferably, in the connector according to (1), the protrusion also protrudes in a direction to narrow an opening width of the through hole, and the twisting prevention projection is provided with a depression that receives the protrusion.

With the configuration in (2), a rib-difference structure can be used in which a plurality of types of first connectors differ in, for example, the formation position of the protrusion in the through hole. This can prevent the first connector from being erroneously fitted to another second connector. In particular, since the protrusion has both the function of suppressing mouth-opening of the through hole and the function of a rib in the rib-difference structure, the configuration can be simplified as compared with the case where the two functions are provided in separate parts.
(3) Preferably, in the connector according to (2), the through hole has an extending inner surface that extends longer in a left-right direction than in an up-down direction, the up-down direction being the direction intersecting the front-rear direction, and the protrusion comprises a plurality of protrusions arranged at intervals in the left-right direction on the extending inner surface of the through hole.

With the configuration in (3), if another twisting prevention projection presses against the extending inner surface of the recess, the plurality of protrusions arranged in the left-right direction can each contact the inner surface of the recess. Erroneous fitting of another second connector to the first connector can thus be prevented more reliably.

### Details of Embodiments of the Present Disclosure

Specific examples of a connector according to the present disclosure will be described below with reference to the drawings. The present disclosure is not limited to these examples, but is defined by the claims and intended to include all modifications within the meaning and scope equivalent to the claims.

### Embodiment 1

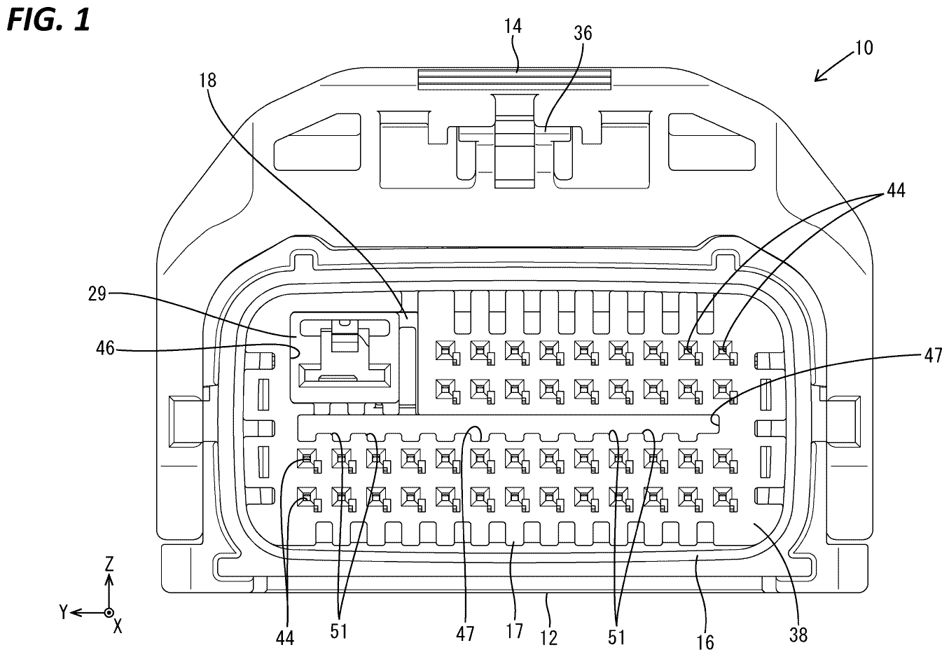

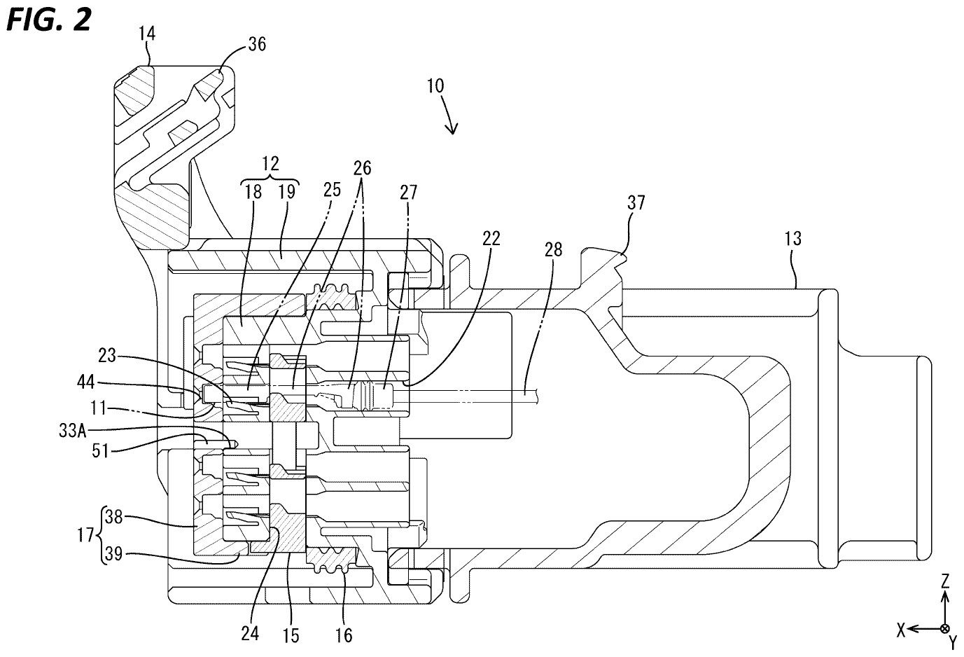

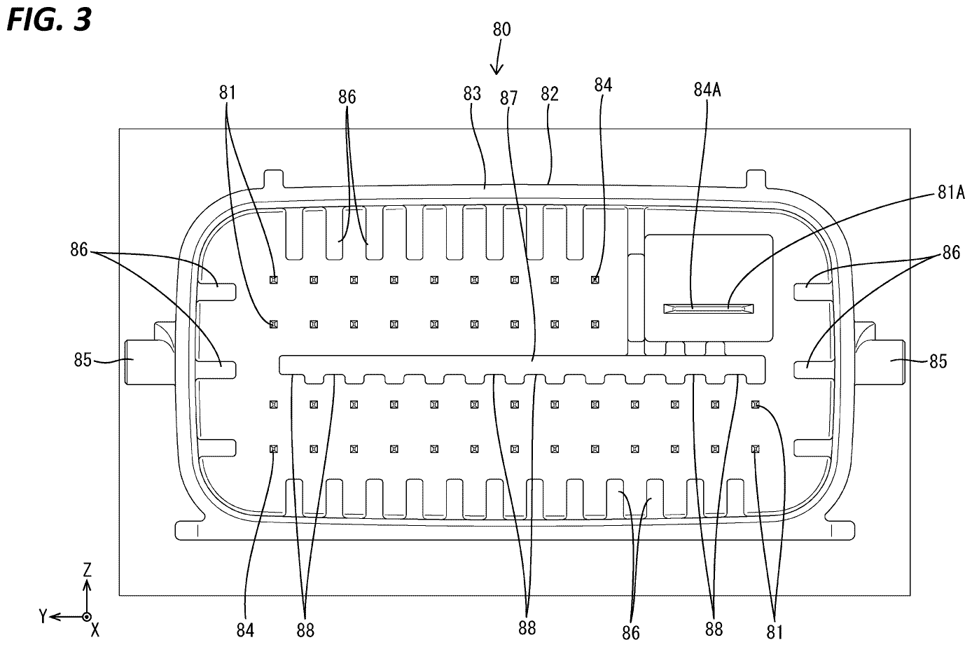

A connector according to Embodiment 1 includes a first connector 10 and a second connector 80 that are fittable together. As shown in FIG. 2, the first connector 10 includes first terminal fittings 11, a first housing 12, a cover 13, a lever 14, a retainer 15, a seal ring 16, and a front member 17. As shown in FIG. 3, the second connector 80 includes second terminal fittings 81 and a second housing 82. In the following description, the front side in the front-rear direction is the surface side where the first connector 10 and the second connector 80 are fitted together. The up-down direction and the left-right direction are based respectively on the up-down direction and the left-right direction in FIGS. 1 and 3. Symbols X, Y, and Z in FIGS. 1 to 3 indicate forward (frontward), leftward, and upward respectively. These directions do not necessarily correspond to the directions in a state in which the connector is mounted in a vehicle or the like (not shown).

### Second Connector 80

The second connector 80 is a male connector. The second housing 82 is a male housing made of synthetic resin, and includes a hood portion 83 as shown in FIG. 3. The hood portion 83 has a rectangular tubular shape with rounded corners and is open forward. In Embodiment 1, the hood portion 83 is longer in the left-right direction than in the up-down direction. A plurality of second terminal fittings 81 are attached to the second housing 82. Each second terminal fitting 81 is a male terminal fitting made of conductive metal, and includes a tab portion 84. The tab portions 84 of the second terminal fittings 81 form a plurality of rows arranged in the up-down direction and a plurality of columns arranged in the left-right direction inside the hood portion 83. One of the second terminal fittings 81 is a second terminal fitting 81A that is larger than the other second terminal fittings 81. The large second terminal fitting 81A includes a tab portion 84A that is wide in the left-right direction, unlike the other second terminal fittings 81. As shown in FIG. 3, the large second terminal fitting 81A is located at an upper part of one end side (right end side) in the left-right direction in a front view of the hood portion 83.

A pair of cam pins 85 (cam followers) protrude from the outer surfaces of the left and right side walls of the hood portion 83. Each cam pin 85 engages with the lever 14 in the fitting process of the first connector 10 and the second connector 80. A plurality of entry suppression ribs 86 are formed on the hood portion 83. In detail, a plurality of entry suppression ribs 86 are arranged in the left-right direction on each of the upper and lower walls of the hood portion 83, and also a plurality of entry suppression ribs 86 are arranged in the up-down direction on each of the left and right side walls of the hood portion 83. The leading end of each entry suppression rib 86 is located forward from the leading end of the tab portion 84 of each second terminal fitting 81. For example, as a result of a fingertip of an operator (not shown) being pressed against the leading end of each entry suppression rib 86 and the leading end of the below-described twisting prevention projection 87, the fingertip can be kept from contacting the leading end of each second terminal fitting 81.

The twisting prevention projection 87 is formed on the hood portion 83. The twisting prevention projection 87 projects forward from the back surface of the hood portion 83. The twisting prevention projection 87 has a flat plate shape that extends in the front-rear direction and the left-right direction. The twisting prevention projection 87 is shaped to extend long from one end to the other end of the hood portion 83 in the left-right direction, in a front view of the hood portion 83. In Embodiment 1, the twisting prevention projection 87 is located between the second and third rows of the tab portions 84 of the second terminal fittings 81 from the top. In other words, the twisting prevention projection 87 is located at the center of the interior of the hood portion 83 in the up-down direction. The leading end of the twisting prevention projection 87 is located forward from the leading end of the tab portion 84 of each second terminal fitting 81. The outer periphery of the leading end of the twisting prevention projection 87 is chamfered and rounded, although not shown in the drawings.

When fitting the first connector 10 and the second connector 80 together, the twisting prevention projection 87 is inserted into the below-described through hole 47 of the front member 17 and further enters the below-described recess 33 of the first housing 12. A plurality of depressions 88 are formed in the twisting prevention projection 87. In FIG. 3, the depressions 88 are arranged at intervals in the left-right direction on the lower surface of the twisting prevention projection 87. Each depression 88 is formed as a groove having a rectangular cross-sectional shape and extending in the front-rear direction on the lower surface of the twisting prevention projection 87. In Embodiment 1, the depressions 88 are repeatedly formed at a constant pitch (i.e. at regular intervals) in the left-right direction on the lower surface of the twisting prevention projection 87. However, the depressions 88 need not be formed at a constant pitch in the left-right direction, and may be arranged in any manner. When fitting the first connector 10 and the second connector 80 together, the below-described protrusions 51 of the front member 17 are fitted into the depressions 88.

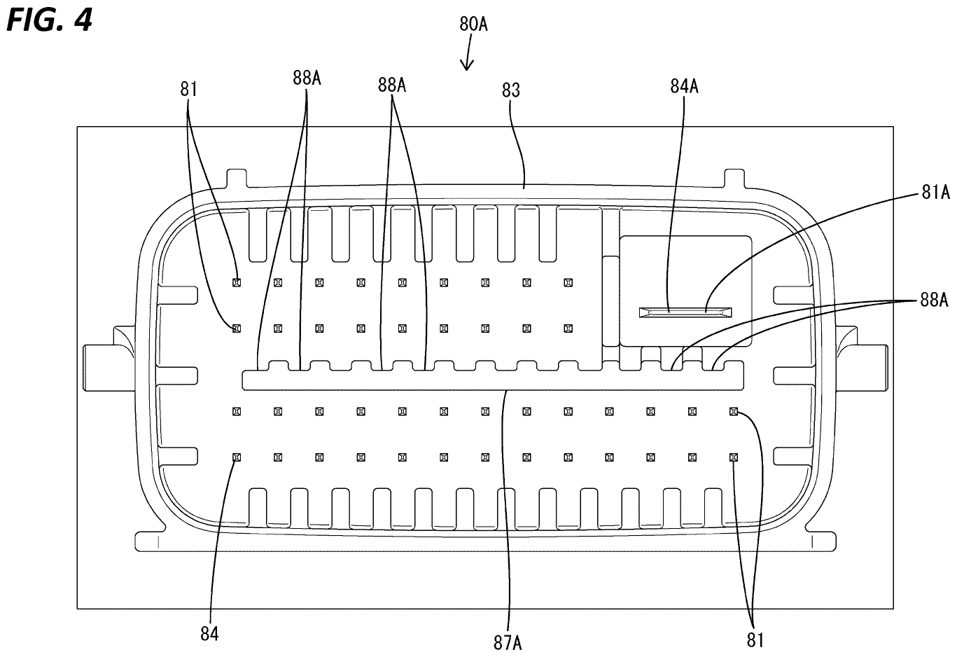

In Embodiment 1, to prevent erroneous fitting of another second connector 80A or 80B including male terminal fittings of the same arrangement and a male housing of the same outer shape to the first connector 10, for example, the twisting prevention projections 87, 87A, and 87B of the respective second connectors 80, 80A, and 80B have their depressions 88, 88A, and 88B formed at different positions from each other. For example, in another second connector 80A, other depressions 88A are formed on the upper surface of another twisting prevention projection 87A, as shown in FIG. 4. The pitch of the other depressions 88A in the left-right direction is the same as that of the depressions 88. For example, in still another second connector 80B, other depressions 88B are formed on both the upper and lower surfaces of another twisting prevention projection 87B. The other depressions 88B are alternately formed on the upper and lower surfaces of the other twisting prevention projection 87B in the left-right direction. On each of the upper and lower surfaces of the other twisting prevention projection 87B, the pitch of the other depressions 88B in the left-right direction is greater than that of the depressions 88.

### First Connector 10

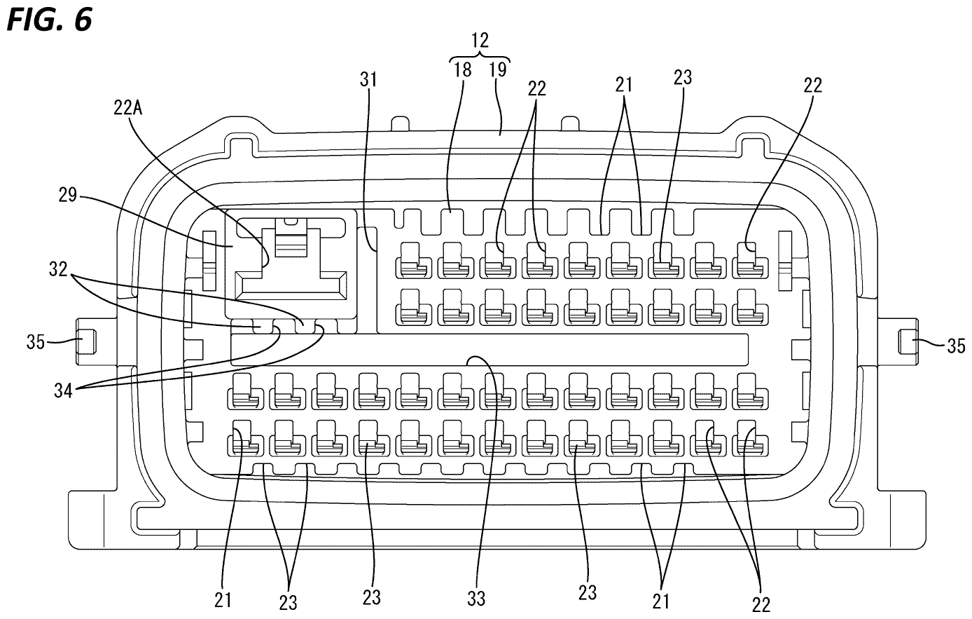

The first connector 10 is a female connector. The first housing 12 is a female housing made of synthetic resin. As shown in FIGS. 2 and 6, the first housing 12 includes a housing body 18 and a surrounding portion 19 that surrounds the outer periphery of the housing body 18. The housing body 18 has a block shape rectangular in a front view with rounded corners, and is longer in the left-right direction than in the up-down direction. The hood portion 83 of the second connector 80 is fitted into the space between the housing body 18 and the surrounding portion 19 from the front.

The seal ring 16 is made of rubber such as silicone rubber, and is attached to the outer peripheral surface of the housing body 18 as shown in FIG. 2. When fitting the first connector 10 and the second connector 80 together, the seal ring 16 is compressed between the housing body 18 and the hood portion 83.

As shown in FIG. 6, a plurality of receiving grooves 21 are formed in the housing body 18. Each receiving groove 21 extends in the front-rear direction on the outer peripheral surface of the housing body 18. The receiving grooves 21 are arranged at intervals in the circumferential direction on the upper surface, lower surface, and left and right side surfaces of the housing body 18, and are open on each of these surfaces. When fitting the first connector 10 and the second connector 80 together, each receiving groove 21 receives a corresponding one of the entry suppression ribs 86.

A plurality of cavities 22 are formed in the housing body 18 at positions corresponding to the tab portions 84 of the second terminal fittings 81. Each cavity 22 extends in the front-rear direction and is open on the front and rear surfaces of the first housing 12. An elastically deformable lance 23 protrudes on the inner wall of each cavity 22. As shown in FIG. 2, an attachment hole 24 is formed at a middle part in the front-rear direction of the lower surface of the housing body 18. The attachment hole 24 communicates with each cavity 22 inside the housing body 18. The retainer 15 is inserted into the attachment hole 24 from below.

Each first terminal fitting 11 is a female terminal fitting made of conductive metal. As shown in FIG. 2, the first terminal fitting 11 includes a tubular box portion 25 and a barrel portion 26 located rearward from the box portion 25. When fitting the first connector 10 and the second connector 80 together, the tab portion 84 is inserted into the box portion 25 from the front. As a result of the tab portion 84 contacting an elastic contact piece (not shown) disposed inside the box portion 25, the first terminal fitting 11 and the second terminal fitting 81 are connected. The barrel portion 26 is crimp-connected to a terminal portion of an electric wire 28 together with a rubber plug 27. In a state in which the first terminal fitting 11 is inserted in the cavity 22, the rubber plug 27 is in close contact with the inner circumferential surface of the cavity 22. The electric wire 28 extends rearward from the first housing 12. The first terminal fitting 11 is primarily retained in the cavity 22 by being locked to the lance 23. The first terminal fitting 11 is secondarily retained in the cavity 22 by being locked to the retainer 15. The first terminal fittings 11 include a large first terminal fitting (not shown). The large first terminal fitting is connected to the large second terminal fitting 81A. As shown in FIG. 6, the housing body 18 includes a large cavity 22A for storing the large first terminal fitting. The large cavity 22A is formed in a tower portion 29 that protrudes from an upper part on one of the left and right sides on the front surface of the housing body 18. A vertical groove 31 that extends in the up-down direction is formed along one side surface of the tower portion 29 on the front surface of the housing body 18. A plurality of vertical ribs 32 are formed side by side in the left-right direction on the lower surface of the tower portion 29.

The cover 13 is made of synthetic resin, and is attached to the first housing 12 as shown in FIG. 2. The electric wires 28 extending from the first housing 12 are covered by the cover 13, and further led out of the cover 13 collectively in a predetermined direction.

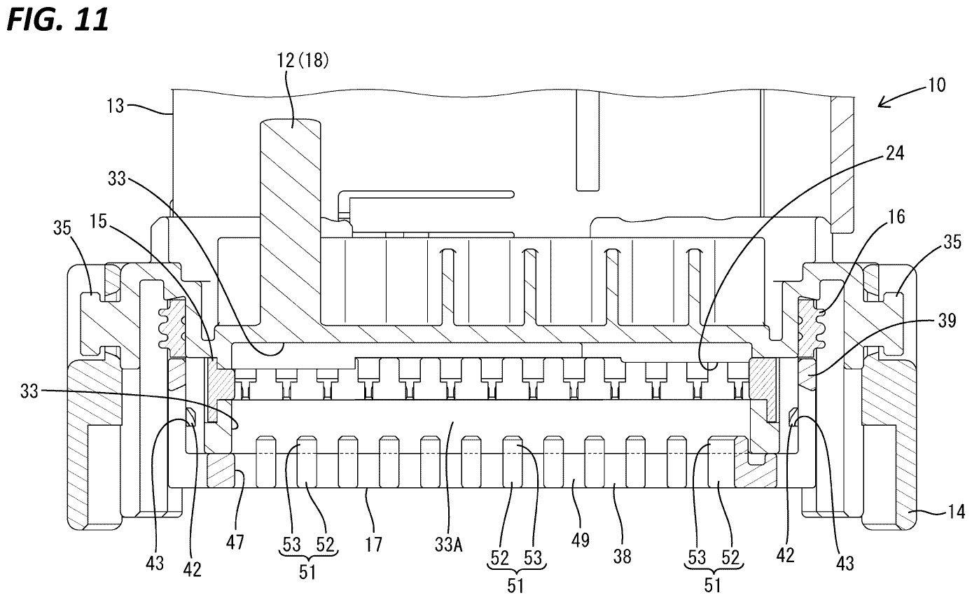

As shown in FIG. 6, the recess 33 is formed on the front surface of the housing body 18. The recess 33 has an opening shape that extends long from one end to the other end in the left-right direction of the front surface of the housing body 18. The recess 33 communicates with recessed space portions 34 between the vertical ribs 32 of the tower portion 29 and also communicates with the vertical groove 31, on one end side in the left-right direction of the front surface of the housing body 18. As shown in FIG. 11, the rear end of the recess 33 is located rearward from the attachment hole 24.

As shown in FIG. 6, a pair of support shafts 35 protrude from the outer surfaces of the left and right side walls of the surrounding portion 19. As shown in FIG. 11, the lever 14 is rotatably supported on each support shaft 35. The lever 14 is made of synthetic resin, and has a gate shape as shown in FIG. 1. As a result of the lever 14 being rotated about the support shafts 35 while engaging with the cam pins 85, fitting between the first connector 10 and the second connector 80 proceeds with a low fitting force. When the rotation of the lever 14 is completed, a lock portion 36 formed on the lever 14 is locked to a lock receiving portion 37 (see FIG. 2) formed on the cover 13, so that the first connector 10 and the second connector 80 are held in the fitted state.

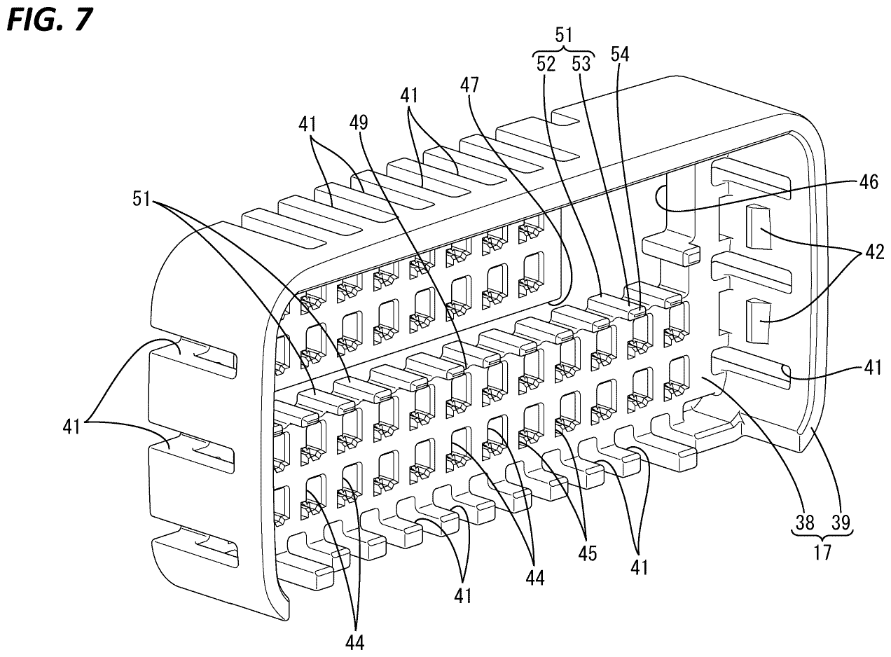

Next, the front member 17 will be described. The front member 17 is made of synthetic resin, and has a cap shape as a whole. As shown in FIG. 7, the front member 17 includes a plate-shaped front wall 38 whose plate surfaces face in the front-rear direction, and a peripheral wall 39 that protrudes rearward from the outer peripheral edge of the front wall 38.

The front wall 38 has a shape that is longer in the left-right direction than in the up-down direction. As shown in FIGS. 1 and 2, the front wall 38 is located so as to cover the front surface part of the housing body 18 excluding the tower portion 29. Each lance 23 is covered from the front by the front wall 38. The peripheral wall 39 is located so as to cover the front end part of the outer peripheral surface of the housing body 18. The rear end of each of the upper wall part and the left and right side wall parts of the peripheral wall 39 faces the seal ring 16 from the front so as to be able to contact the seal ring 16. As shown in FIG. 2, the rear end of the lower wall part of the peripheral wall 39 faces the retainer 15 so as to be able to contact the retainer 15.

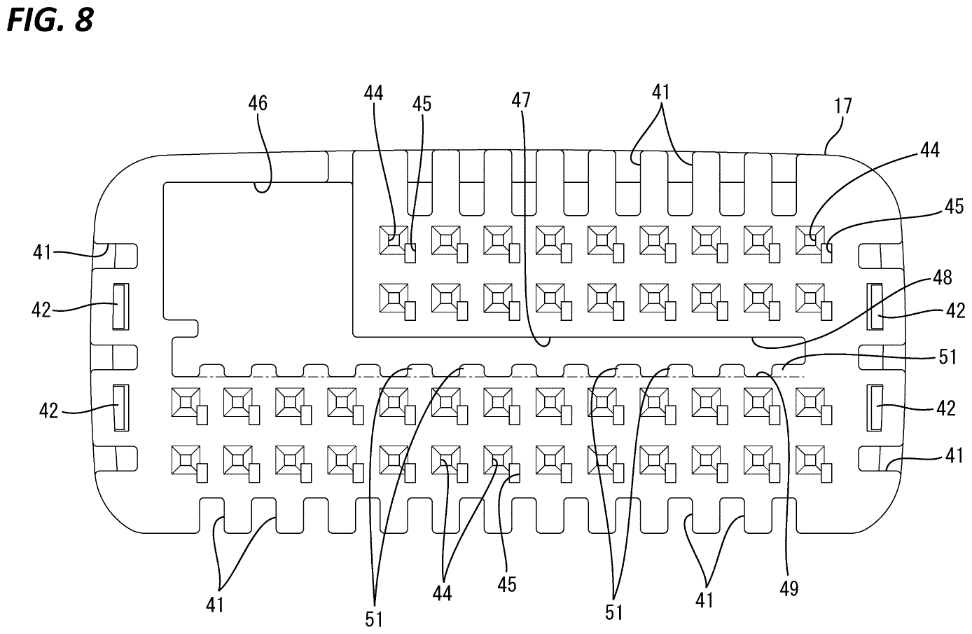

As shown in FIGS. 7 and 8, a plurality of cut grooves 41 are formed at intervals in the circumferential direction on the outer peripheral edge of the front member 17. Each cut groove 41 extends from the front wall 38 to the peripheral wall 39, and is open on the front surface of the front wall 38. In a state in which the front member 17 is attached to the housing body 18, each cut groove 41 communicates with a corresponding one of the receiving grooves 21. When fitting the first connector 10 and the second connector 80 together, each cut groove 41 receives a corresponding one of the entry suppression ribs 86. A pair of locking portions 42 are formed with spacing therebetween in the up-down direction on each of the left and right side wall parts of the peripheral wall 39. Each locking portion 42 is claw-shaped. As a result of each locking portion 42 being fitted into a corresponding one of the locking recesses 43 formed on the left or right side surface of the housing body 18, the front member 17 is held on the housing body 18.

As shown in FIGS. 7 and 8, a plurality of tab insertion holes 44 are formed in the front wall 38. The tab insertion holes 44 form a plurality of rows arranged in the up-down direction and a plurality of columns arranged in the left-right direction so as to correspond to the tab portions 84 of the second terminal fittings 81. The tab portion 84 of each second terminal fitting 81 is inserted through a corresponding one of the tab insertion holes 44. Moreover, a plurality of jig insertion holes 45 are formed in the front wall 38. Each jig insertion hole 45 is located adjacent to a corresponding one of the tab insertion holes 44. A jig (not shown) for releasing the locking of the lance 23 to the first terminal fitting 11 is inserted through each jig insertion hole 45.

A tower through hole 46 is formed in the front wall 38. The tower through hole 46 has a large opening in an upper part on one of the left and right sides of the front wall 38. As shown in FIG. 1, in a state in which the front member 17 is attached to the housing body 18, the tower portion 29 of the housing body 18 is inserted through the tower through hole 46. As shown in FIGS. 7 and 8, a through hole 47 is formed in the front wall 38. The through hole 47 has a slit shape that extends long from one end to the other end in the left-right direction of the front wall 38. The through hole 47 communicates with the tower through hole 46 on one end side in the left-right direction of the front wall 38. In Embodiment 1, the through hole 47 is located between the second and third rows of the tab insertion holes 44 from the top. In other words, the through hole 47 is located at the center of the front wall 38 in the up-down direction. When fitting the first connector 10 and the second connector 80 together, the twisting prevention projection 87 of the second connector 80 is inserted through the through hole 47 in a fitted state.

As shown in FIG. 8, the upper inner surface (surface on the upper side facing downward) and the lower inner surface (surface on the lower side facing upward) of the inner surfaces of the through hole 47 are formed as extending inner surfaces 48 and 49 that extend longer in the left-right direction than in the up-down direction. The upper extending inner surface 48 is perpendicular to the tower through hole 46 at one end in the left-right direction and extends continuously in the left-right direction without steps.

A plurality of protrusions 51 are formed on the front wall 38 at positions facing the through hole 47. Each protrusion 51 protrudes from the inner surface of the through hole 47 so as to narrow the opening width of the through hole 47 in the up-down direction. In Embodiment 1, a plurality of protrusions 51 are arranged at intervals in the left-right direction on the lower extending inner surface 49 (surface at the height of the broken line in FIG. 8). In Embodiment 1, the protrusions 51 are repeatedly formed at a constant pitch in the left-right direction on the lower extending inner surface 49. However, the protrusions 51 need not be formed at a constant pitch in the left-right direction, and may be arranged in any manner according to the depressions 88.

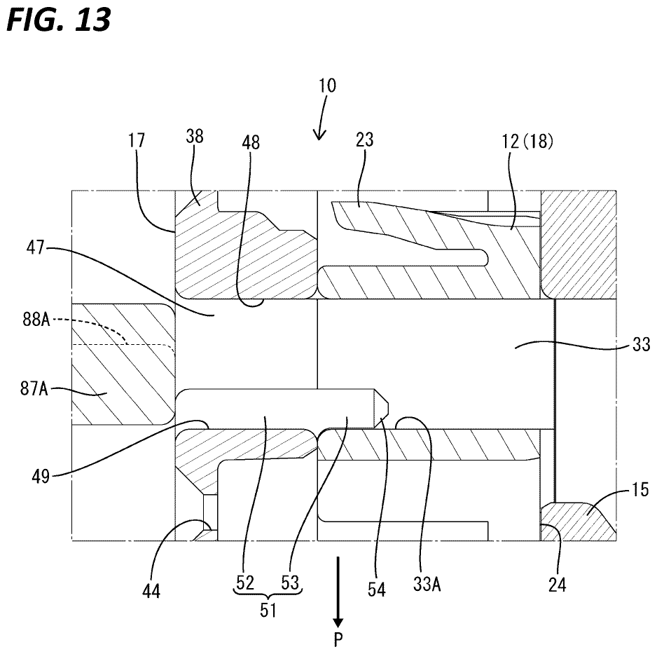

As shown in FIGS. 7, 11, and 13, each protrusion 51 includes a protrusion body portion 52 that protrudes from the lower extending inner surface 49 and a rearward protrusion portion 53 that protrudes rearward from the protrusion body portion 52. The protrusion 51 has a rectangular rib shape extending in the front-rear direction from the protrusion body portion 52 to the rearward protrusion portion 53. The protrusion body portion 52 is formed over the entire length of the lower extending inner surface 49 in the front-rear direction so as to correspond to the thickness of the front wall 38 in the front-rear direction. As shown in FIG. 13, the front surface of the protrusion body portion 52 extends in the up-down direction and the left-right direction except for chamfering at the outer periphery of the leading end. The rearward protrusion portion 53 protrudes rearward from the rear surface of the front wall 38. As shown in FIG. 7, the protrusion body portion 52 and the rearward protrusion portion 53 have a rectangular cross-sectional shape that is longer in the left-right direction than in the up-down direction. With the same cross-sectional shape, the protrusion body portion 52 and the rearward protrusion portion 53 are continuous without steps. A tapered portion 54 that narrows toward the leading end is formed at the rear end of the rearward protrusion portion 53.

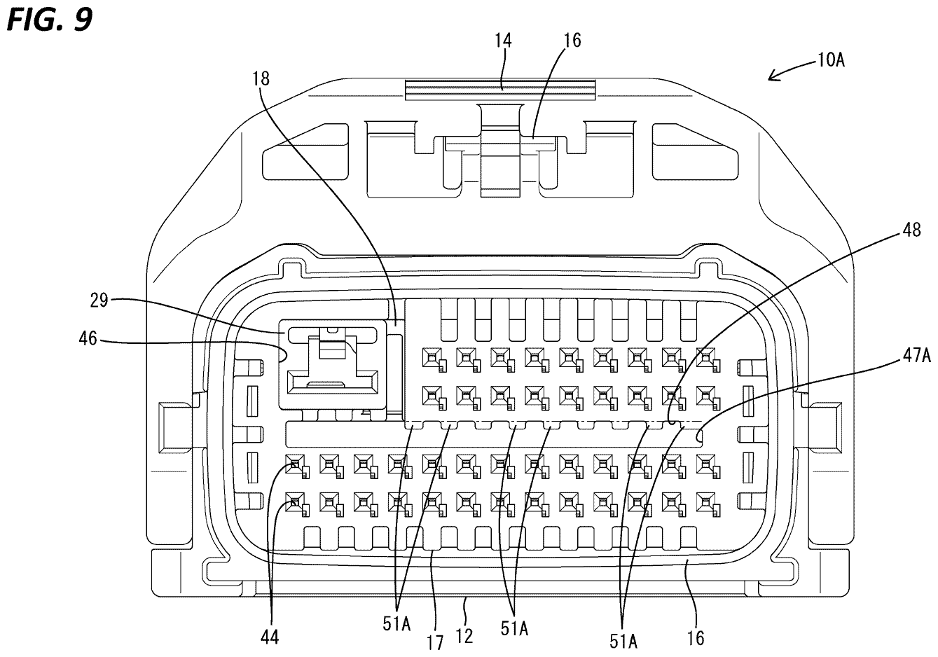

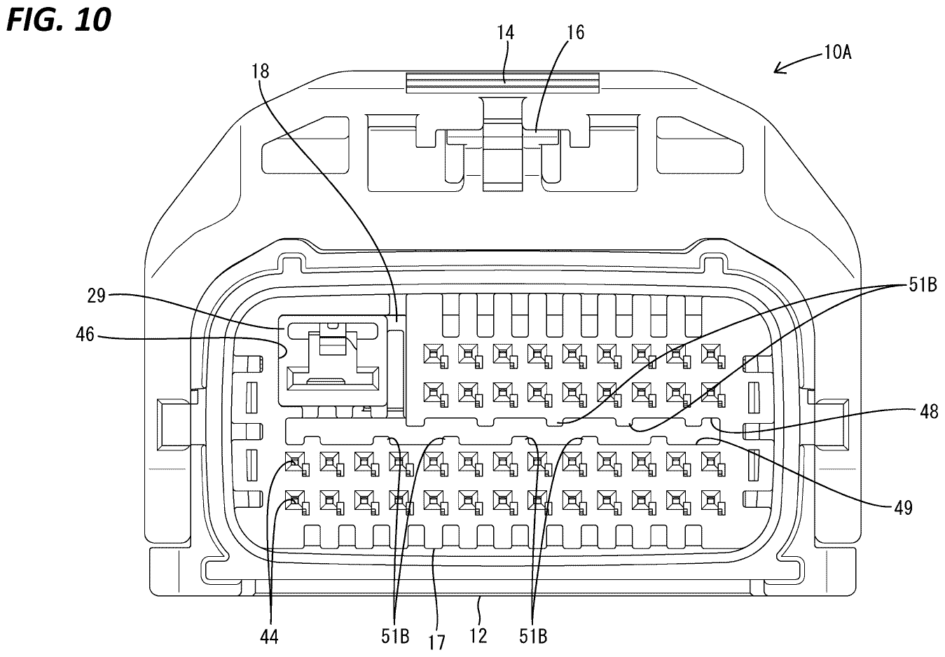

When fitting the first connector 10 and the second connector 80 together, each protrusion 51 properly fits into a corresponding one of the depressions 88 of the twisting prevention projection 87. On the other hand, as shown in FIG. 9 or 10, another first connector 10A or 10B including female terminal fittings of the same arrangement and a female housing of the same outer shape as the first connector 10 is provided with other protrusions 51A or 51B whose formation positions with respect to the through hole 47 differ from those of the protrusions 51. Due to this rib-difference structure, the other protrusions 51A or 51B do not fit into the depressions 88. Erroneous fitting another first connector 10A or 10B to the second connector 80 can thus be prevented.

For example, in another first connector 10A, a plurality of other protrusions 51A are arranged at intervals in the left-right direction on the upper extending inner surface 48 (surface at the height of the broken line in FIG. 9), as shown in FIG. 9. The pitch of the other protrusions 51A in the left-right direction is the same as that of the protrusions 51. Since the other protrusions 51A properly fit into the other depressions 88A, fitting between the other first connector 10A and the other second connector 80A is enabled.

For example, in still another first connector 10B, other protrusions 51B are formed on both the upper extending inner surface 48 and the lower extending inner surface 49, as shown in FIG. 10. The other protrusions 51B are alternately formed on the upper extending inner surface 48 and the lower extending inner surface 49 in the left-right direction. On each of the upper extending inner surface 48 and the lower extending inner surface 49, the pitch of the other protrusions 51B in the left-right direction is greater than that of the protrusions 51. Since the other protrusions 51B properly fit into the other depressions 88B, fitting between the other first connector 10B and the other second connector 80B are enabled.

### Functions of Connector

In the assembled state of the first connector 10, the front wall 38 of the front member 17 covers the front side of the housing body 18, so that the rearward protrusion portions 53 of the protrusions 51 face the lower inner surface 33A (surface on the lower side facing upward) of the recess 33 of the housing body 18 so as to be able to contact the lower inner surface 33A (see FIG. 13). As shown in FIG. 11, the rearward protrusion portions 53 of the protrusions 51 are arranged at intervals in the left-right direction so as to be able to contact the lower inner surface 33A of the recess 33.

When the first connector 10 and the second connector 80 are fitted together, the tab portions 84 of the second terminal fittings 81 are inserted into the tab insertion holes 44 of the front member 17 to the cavities 22 of the housing body 18, and connected to the first terminal fittings 11 stored in the cavities 22. The twisting prevention projection 87 is inserted into the through hole 47 of the front member 17 to the recess 33 of the housing body 18. The protrusions 51 properly fit into the respective depressions 88 of the twisting prevention portion.

For example, if an attempt is made to erroneously fit another second connector 80A different from the second connector 80 to the first connector 10, another twisting prevention projection 87A may forcibly increase the opening width of the through hole 47 in the up-down direction while being guided by the roundness of the outer periphery of its leading end. If such mouth-opening, i.e. the increase of the opening width of the through hole in the up-down direction, occurs, there is a possibility that the twisting prevention projection is forcibly inserted into the through hole and, in the worst case, the other second connector is erroneously fitted to the first connector.

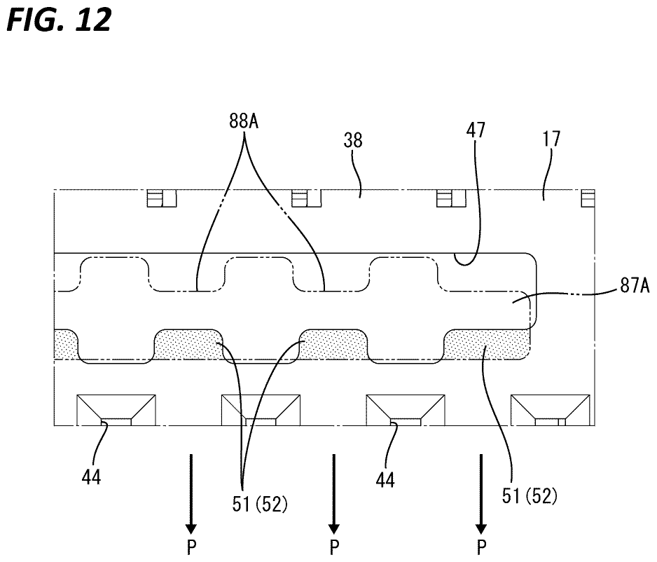

For example, as shown in FIG. 12, the leading end surface of the other twisting prevention projection 87A may contact the front surface of the protrusion body portion 52 of each protrusion 51 (the shaded area in FIG. 12 indicates the contact area), and a pressing force P may act on the through hole 47 in a mouth-opening direction in which the lower extending inner surface 49 separates from the upper extending inner surface 48. In this case, in Embodiment 1, the rearward protrusion portion 53 of the protrusion 51 can contact the lower inner surface 33A of the recess 33 in the mouth-opening direction of the through hole 47 (direction in which the pressing force P acts), as shown in FIG. 13. Therefore, the rearward protrusion portion 53 of the protrusion 51 is kept from moving to a position lower than the lower inner surface 33A of the recess 33, and the separation of the lower extending inner surface 49 from the upper extending inner surface 48 is suppressed. Thus, mouth-opening of the through hole 47 is suppressed. As a result, forced insertion of the other twisting prevention projection 87A into the through hole 47 can be avoided, and erroneous fitting of the other second connector 80A to the first connector 10 can be reliably prevented. Hence, the rib-difference structure can further enhance reliability in preventing erroneous fitting.

As described above, the connector according to Embodiment 1 includes a first connector 10 and a second connector 80 that are fittable together. The first connector 10 includes a first housing 12 and a front member 17. The front member 17 includes a plate-shaped front wall 38 whose plate surfaces face in a front-rear direction. The front wall 38 faces a front surface of the first housing 12. A through hole 47 is formed in the front wall 38. A recess 33 that communicates with the through hole 47 is formed on the front surface of the first housing 12. The second connector 80 includes a twisting prevention projection 87 that is located from the through hole 47 to the recess 33 in a state in which the first connector 10 and the second connector 80 are fitted together. A protrusion 51 that protrudes into the recess 33 and is capable of contacting an inner surface of the recess 33 in a direction (downward in FIGS. 12 and 13) intersecting the front-rear direction is formed in a part of the front wall 38 facing the through hole 47.

For example, even if an attempt is made to fit another second connector 80A or 80B to the first connector 10 and another twisting prevention projection 87B or 87B presses against the hole surface of the through hole 47, the rearward protrusion portion 53 of the protrusion 51 can contact the inner surface (lower inner surface 33A in FIGS. 12 and 13) of the recess 33 in the direction intersecting the front-rear direction, so that mouth-opening of the through hole 47 can be avoided. Erroneous fitting of another second connector 80A or 80B to the first connector 10 can thus be prevented.

In Embodiment 1, the protrusion 51 also protrudes in a direction to narrow an opening width of the through hole 47. A depression 88 that receives the protrusion 51 is formed in the twisting prevention projection 87. Thus, a rib-difference structure can be used in which a plurality of types of first connectors 10 differ in, for example, the formation position of the protrusion 51 in the through hole 47. This can prevent the first connector 10 from being erroneously fitted to another second connector 80A or 80B. Since the protrusion 51 has both the function of suppressing mouth-opening of the through hole 47 and the function of a rib in the rib-difference structure, the configuration can be simplified as compared with the case where the two functions are provided in separate parts.

Moreover, in Embodiment 1, the through hole 47 has extending inner surfaces 48 and 49 that extend longer in a left-right direction than in an up-down direction, and the protrusion 51 comprises a plurality of protrusions 51 arranged at intervals in the left-right direction on the lower extending inner surface 49 of the through hole 47. With this configuration, if another twisting prevention projection 87A or 87B presses against the lower extending inner surface 49 of the recess 33, the plurality of protrusions 51 arranged in the left-right direction can each contact the inner surface of the recess 33. Erroneous fitting of another second connector 80A or 80B to the first connector 10 can thus be prevented more reliably.

### Other Embodiments of the Present Disclosure

The foregoing Embodiment 1 disclosed herein is illustrative and not restrictive in all respects.

In Embodiment 1, the protrusions protrude from the inner surface of the recess. In another embodiment, for example, the protrusions may protrude only from the rear surface of the front member without protruding into the recess, as long as the protrusions are located at positions facing the inner surface of the recess.

In Embodiment 1, the protrusions have both the function of suppressing mouth-opening of the through hole and the function of ribs in the rib-difference structure. In another embodiment, the protrusions may only have the function of suppressing mouth-opening of the through hole without the function of ribs in the rib-difference structure. If the protrusions do not have the function of ribs in the rib-difference structure, the ribs of the rib-difference structure may be independently formed on the inner surface of the through hole in addition to the protrusions.

In Embodiment 1, a plurality of protrusions are formed at positions facing the through hole of the front member. In another embodiment, only one protrusion may be formed at a position facing the through hole of the front member. The one protrusion may be formed to be wide in the left-right direction.

In Embodiment 1, the protrusions are formed on the lower extending inner surface of the through hole. In another embodiment, the protrusions may be formed on the upper extending inner surface of the through hole. The protrusions may be formed on both the upper and lower extending inner surfaces of the through hole.

In Embodiment 1, the front member does not have the retainer function of locking the first terminal fittings. In another embodiment, the front member may have the retainer function of locking the first terminal fittings.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector comprising a first connector and a second connector that are fittable together,
wherein the first connector includes a housing and a front member,
the front member includes a plate-shaped front wall whose plate surfaces face in a front-rear direction,
the front wall faces a front surface of the housing,
the front wall is provided with a through hole,
the front surface of the housing is provided with a recess that communicates with the through hole,
the second connector includes a twisting prevention projection that is located from the through hole to the recess in a state in which the first connector and the second connector are fitted together, and
a part of the front wall facing the through hole is provided with a protrusion that protrudes into the recess and is capable of contacting an inner surface of the recess in a direction intersecting the front-rear direction.

2. The connector according to claim 1, wherein the protrusion also protrudes in a direction to narrow an opening width of the through hole, and
the twisting prevention projection is provided with a depression that receives the protrusion.

3. The connector according to claim 1, wherein the through hole has an extending inner surface that extends longer in a left-right direction than in an up-down direction, the up-down direction being the direction intersecting the front-rear direction, and
the protrusion comprises a plurality of protrusions arranged at intervals in the left-right direction on the extending inner surface of the through hole.
